(19) United States
(12) Patent Application Publication
(10) Pub. No.: US 2014/0290121 A1
(43) Pub. Date: Oct. 2, 2014

(54) LONGLINE FISHING APPARATUS

(71) Applicant: Adam Matthews, Waipu (NZ)

(72) Inventor: Adam Matthews, Waipu (NZ)

(21) Appl. No.: 14/352,083

(22) PCT Filed: Oct. 18, 2012
(86) PCT No.: PCT/NZ2012/000190

§ 371 Date: Apr. 16, 2014

(30) Foreign Application Priority Data
Oct. 18, 2011 (NZ) 595814
Feb. 7, 2012 (NZ) 598059
Mar. 3, 2012 (NZ) 599146

(51) Int. Cl. A01K 91/18; A01K 95/00; A01K 93/00

(52) U.S. Cl. CPC A01K 91/18; A01K 93/00; A01K 95/00
USPC 43/57.3

(57) ABSTRACT

A long line fishing apparatus comprises a reel, a support member, guide means and hook retaining means. The reel includes a core connected between a first flange and second flange, for winding or unwinding a fishing line thereon said core between the first and second flanges. The reel is attached to the support member and the guide means is attached to the support member. Hook retaining means is formed as at least one slot in the first flange so that at least one hook attached to the fishing line can be retained in at least one slot. Movement of the position of the reel away from an end of the fishing line causes the reel to rotate in a horizontal plane to cause the fishing line to be deployed through the guide means or to be able to be rewound back on the reel through the guide means without tangling.

### CROSS REFERENCE TO RELATED APPLICATIONS

This application claims priority to the following patent applications: (1) Patent Cooperation Treaty Application PCT/NZ2012/000190 filed Oct. 18, 2012; (2) New Zealand Application No. 595814 filed Oct. 18, 2011; (3) New Zealand Application No. 598059 filed Feb. 7, 2012; and (4) New Zealand Application No. 599146 filed Mar. 30, 2012 each of the above cited applications is hereby incorporated by reference herein as if fully set forth in its entirety.

The invention relates to a long line fishing apparatus for fishing and to a method of operation. The invention is directed particularly but not solely towards a long line fishing apparatus for automatic feeding out.

### BACKGROUND OF INVENTION

Long line fishing is a technique of fishing by laying out a line with several baited hooks attached at intervals by means of branch lines called trace lines or snoods. The trace lines are short lengths of line attached to the main line by a clip or swivel. The main line can be called a backbone line. The backbone will have a grapple or anchor at, at least one end of the main line which in use sits on the seafloor whereby the grapple is then connected to a float line or dropper line leading from main line on the seafloor upwardly, to a float. Some long lines can be set at the surface but with a different arrangement for the main line, dropper line and grapples.

In New Zealand like many countries long line fishing has a bad name due to indiscriminate overfishing and needless killing of various mammals like turtles, seabirds and sharks. There are rules to alleviate or limit overfishing and the indiscriminate killing, like limiting the number hooks.

Existing long lines consist in a vertical reel having the main line wound thereon. Operationally the vertical reel can be mounted with its own mounting shaft to be slidably supported by a fishing pole mounting. To assemble a long line with bait, a tracer board is used to position tracers with hooks whereby the hooks are attached to the tracer and bait is then attached to each hook (eg re-curve hooks).

Other means such as hook floats can be placed thereon. This type of assembly with a tracer board is difficult to carry out on a boat. They require a separate apparatus to arrange the tracers with hooks to enable one to put the bait on. This separate apparatus represents yet another cost and item that has to be supported, cleaned and stored.

Other problems with existing assemblies include the need for extra steps while trying to feed out the line, of having to attach tracers with the hooks and bait, as the main line is being fed out from the reel. The same problem also occurs when retrieving the long line as either the tracers with hooks have to be removed or they somehow need to be rewound with high possibility of entangling. Like the assembly with the tracer board the feeding and retrieving steps can also be very difficult to do on a moving boat as a result of weather conditions and water movement whereby tangling may occur. This means that feeding out the line can be a complicated and stressful process.

In this specification unless the contrary is expressly stated, where a document, act or item of knowledge is referred to or discussed, this reference or discussion is not an admission that the document, act or item of knowledge or any combination thereof was at the priority date, publicly available, known to the public, part of common general knowledge; or known to be relevant to an attempt to solve any problem with which this specification is concerned.

### OBJECT OF THE INVENTION

It is an object of the invention to provide a long line fishing apparatus and method of operation that ameliorates some of the disadvantages and limitations of the known art or at least provide the public with a useful choice.

### SUMMARY OF INVENTION

In a first aspect the invention resides in a long line fishing apparatus comprising a reel able to rotate in one direction for unwinding and in an opposing direction for winding the fishing line on to the reel and hook retaining means, the reel including a core connected between a first flange and second flange, for winding or unwinding a fishing line thereon said core between the first and second flanges, at least one of the flanges having an outer periphery edge and a centre of rotation, the fishing line including at least one hook, the reel being pivotally attached to the support member, and hook retaining means being formed as at least one slot in the first flange so that at least one hook can be retained in the at least one slot slot wherein each slot is orientated at an angle with respect to the periphery edge wherein the angle includes an acute angle and obtuse angle, whereby the acute angle is provided on a leading side of each slot when unwinding and is provided on a trailing side of each slot when winding, wherein the slots are sized to only receive the line whereby the hooks protrude on top of the first flange.

Preferably the fishing line has a dropper backbone whereby the hooks are removably attached to trace lines and the said an end of the fishing line has at least one float or at least one anchor weight there attached, whereby movement of the reel with respect to the end of the fishing line is caused by movement of at least one float or anchor weight moving away from the reel.

Preferably, the support member is a shaft having ends, being vertically mountable in a a hole on a support surface of a boat wherein one end of the shaft is slotted to allow the shaft to not move when the reel is being moved and the other end being removably attached to the reel.

Preferably the first flange in use is an upper flange which is parallel to the second flange which in use can be a lower flange.

Preferably the reel is oriented at right angles to the shaft.

Preferably the other end is an upper end of the shaft which includes a protruding portion that is slidably mounted within a complementary aperture in the centre of the reel enabling the reel to rotate around and about the protruding portion.

Preferably, the upper flange is adapted to provide an outer surface for use as a baiting table and storage for baited our un-baited hooks on trace lines.

Preferably, the slots are angled tangentially to a diameter of a circle of the reel, being greater than 100 mm whereby the slots are not parallel with one another.

Preferably, each slot has a bevelled corner to assist in allowing the fishing line to be wound or unwound on to a hub of the reel and into or out of the slot.

Preferably, the guide means comprises a slotted member attached to a horizontal elongate member wherein the slotted member is oriented vertically to provide an upwardly facing guide slot, which is spaced from a periphery of the reel and is located substantially adjacent the fishing line as stored on the core between the first and second flanges to allow suitable guiding wherein the slotted member is a U-shaped member.

Preferably there is provided a clutch mechanism shaped and adapted to slow down or not the reel 2 with respect to the shaft 4, wherein the clutch mechanism includes a spindle extension member which extends from the spindle above the upper flange of the reel, having biasing means located surrounding the spindle extension which is held on the spindle extension member and the upper flange by a threadably engaged operating handle so that the reel 2 is seated on a seat member on the top of the shaft, whereby the reel is sandwiched between the biasing means with the handle and the seat member such that rotation of the reel is restricted slowed or released.

Preferably there is provided at least one shaft extension member adapted to removably join a lower end of the shaft whereby the shaft extension member has one end ie a lower end when in use, to be located in the hole of the support surface of a boat and an upper end adapted to slidably receive the lower end of the shaft 4.

In a second aspect the invention resides in a method of deploying a long line from a long line fishing apparatus on a boat as disclosed in the first aspect, the steps including:

1. The guide means 10 is secured in an inboard position with respect to the boat, so that the reel 2 cannot get in the way of the line being deployed;
2. A float 22 is clipped to the dropper 18 on the reel 2 and the dropper line 18 is then run out as the boat motors away upwind or drifts downwind causing the reel to rotate and when the other end of the dropper line 18 appears on the reel 2, an anchor weight 23 is then clipped on to a junction of the dropper line/backbone line 15 and dropper line 18;
3. As the anchor weight 23 moves away from reel, the reel further rotates so that the backbone line 15 is run out which pulls the trace lines 20 with baited hooks from the hook carousel in sequence to set the long line on the seafloor;
4. When a backbone line 15 and second dropper line 18 junction appears, a second anchor weight 23 is then clipped on;
5. As the anchor weight moves away from the reel, the reel further rotates so that the second dropper line 18 is run out and a float 22 then attached to free end of the dropper line 18.

In a third aspect the invention resides in a method of retrieving a long line from a long line fishing apparatus on a boat as disclosed in the first aspect, the steps including:
1. The line guide 10 of the long line fishing apparatus 1 is set to an outboard position to support the incoming line;
2. The first float 22 is then unclipped from its dropper line 18, the dropper line 18 is clipped to the reel 2 and the dropper line 18 is then reeled in manually over the guide means 10;
3. The first anchor weight 23 is unclipped and the backbone line 18 is then reeled in, as each trace line 20 is recovered, any fish or remaining bait is removed from the hook and the hook is secured to the slots 28 of the upper wall 12 of the reel with a slight tension on the trace line 20;
4. With all hooks re-secured on the upper reel flange wall 12 of the reel 2, the second anchor weight 23 is unclipped, the second dropper line 18 is then reeled in and the second float 22 unclipped.

### BRIEF DESCRIPTION

The invention will now be described, by way of example only, by reference to the accompanying drawings:

FIG. 1 is a perspective view of the long line fishing apparatus in accordance with a first preferred embodiment of the invention.

FIG. 2 is a plan view of the long line fishing apparatus

FIG. 3 is a left hand side view based on FIG. 2

FIG. 4 is a front view based on FIG. 2.

FIG. 5 is a close up top view of the reel.

FIG. 6 is a side view of the reel of FIG. 5.

FIG. 7 is a schematic view of one example of long lines that can be use with the invention.

FIG. 8 is a cross sectional view of another embodiment of the long line fishing apparatus.

FIG. 9 is a similar view to FIG. 8 but with reel is a different position.

FIG. 10 is a right hand view of the apparatus based on FIG. 8.

FIG. 11 is a side view of a shaft extension means

FIG. 12 is a top plan view of the apparatus of FIG. 8.

### DESCRIPTION OF DRAWINGS

The following description will describe the invention in relation to preferred embodiments of the invention, namely a long line fishing apparatus and method of operation. The invention is in no way limited to these preferred embodiments as they are purely to exemplify the invention only and that possible variations and modifications would be readily apparent without departing from the scope of the invention.

As shown in FIGS. 1-10 there is a long line fishing apparatus 1 which includes a reel 2 which is movably mounted to a protruding portion in the form of a spindle 3 which is connected or joined to a support member 4 which is a shaft member. One end of the shaft member 4 is adapted to be slidably centrally mounted to the reel which is adapted to allow the reel to rotate in a substantially horizontal plane while the shaft member 4 is substantially oriented vertically. In use one end of the shaft member 4 is adapted to be slidably mounted to any suitable slot 5 on a support surface 6, like for example a rod mounting hole on a boat. Long line fishing apparatus also has a guide means 10 for guiding the line.

Reel 2 includes a cylindrical core 11 and circular walls or flanges 12 & 13 located at each end of cylindrical core 11 to form a space there between. As shown in FIGS. 2-5 one of the flange can be called a first flange or as in use an upper flange 12 and the other flange can be called a second flange or as in use is a lower flange 13 which are oriented substantially parallel, and horizontally when in use. Reel 2 is an object around which another material that is long and flexible such as a fishing line, is able to be wound or unwound there around the core or hub 11 in the space between the upper and lower flanges 12 & 13.

As shown in FIG. 7 in use, the fishing line for the long line apparatus 1 includes a main line in the form of a backbone line 15 (for use as ground lines on the sea floor 16) having a length 17, with at least one dropper line or buoy line 18 leading downwardly from the surface 19 to the backbone 15 and trace lines or snoods 20 extending along the length 17 of the backbone 15. The trace lines 20 have hook means 21 in the form of re-curve hooks. Float means such as at least one float(s) or ‘danbouys’ 22 are clipped onto the dropper line 18 at an end close to the surface 19 and weight means in the form of at least one grapple or anchor weight 23 is clipped on to the other end of the dropper line 18. There are knots or loops positioned at the either end of the dropper line or at various junctions between the lines, to assist in clipping a float or anchor in place. During use, as the boat moves away from the float either by drifting or motoring and/or when the anchor means is dropped overboard (eg down to the seafloor, lake bed or riverbed) or as the reel is moved away from an end of the fishing line having at least one float or anchor weight thereon, the reel is caused to rotate about the shaft member 4, causing the fishing line to be deployed without tangling. This relative movement between the boat and the float or anchor weight can also described as being relative movement between the reel to an end of the fishing which can have a float or anchor thereon.

Reel upper wall 12 is a circular shaped planar member with a diameter having an outer surface 25 with a central hole 26, and peripheral edge 27 and at least one slot 28. In this example, there can be a plurality of hook receiving means in the form of slots 28 are provided in a portion of the upper wall 12 which extend at least a portion of the diameter of the circular planar member inwardly from the peripheral edge 27 but not towards the central hole 26 which are sized to receive each trace line 20 with a hook thereon, as seen in FIG. 1. Slots 28 are oriented at a constant angle 29 with respect to the periphery edge 27 which is not at right angles but is such an angle which causes the slots 28 to be oriented at a different angle to each other as one travels the peripheral edge 27. As shown in FIG. 5 angle 29 can be set by having a tangent 30 to a circle 31 of diameter of 150 mm.

This angle 29 is designed to allow each trace line 20 to more easily exit and or enter the slot 28 as the reel is being rotated by winding the reel by operating reel winder 35. As can be seen in FIGS. 1-3 winder 35 is in the form of an elongate member extending in an upright fashion from a peripheral portion of the outer upper surface 25 of the upper wall 12. Winder 35 is pivotally mounted to the upper wall 12 to enable either clockwise or anticlockwise rotation to deploy to feed or retrieve the fishing line.

For example, some measurements include the upper wall which can be formed from UV stabilized PVC with a thickness 36 of 6 mm. As shown in FIG. 5 the first flange 12 has at leas one slot 28 having a substantially horizontal length 37 of 45 mm, angled at so many degrees with respect a tangent 32 at a circle of diameter 150 mm. Each slot 28 goes to forms a tab like member 38 in between the slots 28 whereby a peripheral corner part 39 of each tab can be angled or bevelled (or cut the slots 28 to remove a trailing corner of each tab) to assist in the feed or retrieval of the fishing line whereby the corner part 38 can have dimensions 40 of 10 mm along the periphery and at right angles a dimension 41 of 8 mm inwardly. Each slot 28 can be dimensioned to allow only a fishing line there through or therein and have a slot width 42 of say for example 1.5 mm. As shown in FIG. 1 because each slot 28 is only able to allow the tracer line 20 therethrough, when the trace lines 20 with hooks are wound on the reel, each trace line 20 is placed through to an end of each slot 28 with hook protruding on top of the flange 12 being in tension to cause each hook to be clipped downwards with the sharp end abutting or facing downwards ie point held down. The central hole 26 can have a diameter of 8 mm. The corner part 39 is located on a forward or leading side of the entrance of each slot when winding (i.e. in an anticlockwise direction). The corner part 39 is located on a rear or trailing side of the entrance of the slot 28, when unwinding (i.e. in clockwise direction).

The spindle 3 on the shaft 4 comprises an elongate member protruding from one end of the shaft 4 which can be a diameter less than the diameter of the shaft 4 be sized such that it is able to slidably centrally inserted into the reel central hole to in use allow the reel to be able to be rotated. Spindle 3 can be formed from a weather resistant material such as stainless steel and the shaft 4 can be formed from timber or steel or stainless steel or plastics or any combination thereof.

The guide means 10 consists in at least one substantially L shaped member formed from an elongate member whereby there is a base member attached to the shaft 4 and a flange member. The base member includes at least one elongate member portion 45 joined to a sleeve member portion 46 which is able to be end capped to one end of the shaft 4 to enable the elongate member portion 45 portion to extend substantially horizontally. The flange member includes at least one elongate member portion 47 extending upwardly and vertically from the horizontal elongate member 45 to end in a slotted member which in this example can be a U shaped portion 48 having arms 49. The U shaped portion can also have a lower central support 45a joined at right angles to the horizontal member 45. In use the U shaped portion is oriented substantially upwardly facing as shown in FIG. 1. Elongate member 45 can be for example 6 mm diameter 316SS. The U shaped portion or member can be located anywhere adjacent the periphery of the reel or core that allows suitable guiding. E.g. this can be spaced in line above or below the real periphery.

As shown in FIG. 7 there can be two dropper lines 18 on the backbone line 15 and twenty five trace lines 20 with hooks wound onto a vertical axis and horizontally spooling reel 2 to form a hook carousel or bait board. Each dropper line 18 has an anchor weight 23. The trace lines 20 are wound counter to the backbone 15 under slight tension to ensure that the backbone 15 will pull the hooks in sequence from their slots 28 as the backbone 15 is deployed from the reel 2. The upper flange 12 of the reel 2, the hook carousel securely holds the hooks in angled, slots 28 in the periphery of the bait board.

FIGS. 8-12 show another embodiment of the invention whereby the long line fishing apparatus can also include a clutch mechanism 50 whereby the rotation of the reel 2 can be adjustably changed as required by the user operating a drag control means in the form of a drag handle 52 centrally located at a distal end of the spindle 3 or 53 which is in turn connected or joined to a top or end of the shaft 4 (eg can be 316SS in combination with wood or entirely made of each) of the reel to be moved. Also there is a handle 35 to allow one to rotate the reel as required. Spindle 3 or 53 extends upwardly when looking at FIGS. 9 & 10 (and also FIGS. 3 and 4) but in this embodiment, extends beyond the upper surface 25 of the reel 2 in an extension portion 53 that has a length to allow a biasing means 54 like for example a spring to be slidably captured. Extension portion 53 is oriented vertically when in use or in the same axis as the shaft 4 to co-linear.

The spring 54 is circular and has a diameter larger than the diameter of the spindle extension and so surrounds the spindle extension wherein during use the spring is compressed by the drag control or drag handle 52. The spindle extended portion has an outer thread thereon, to allow the mutually threaded but located within the drag handle 52 can rotate clockwise or anticlockwise push down or release the reel 2 there against a seat member 58. Seat member can be shaped as a disc-like member located and fixed to the top end of the shaft 3 ie at the end closest to the reel 2.

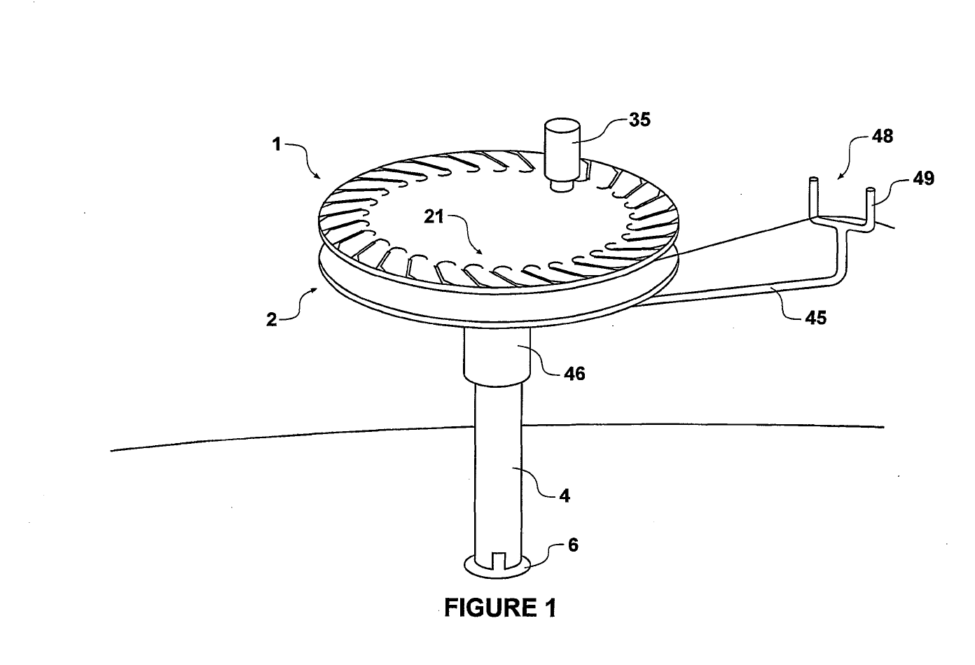

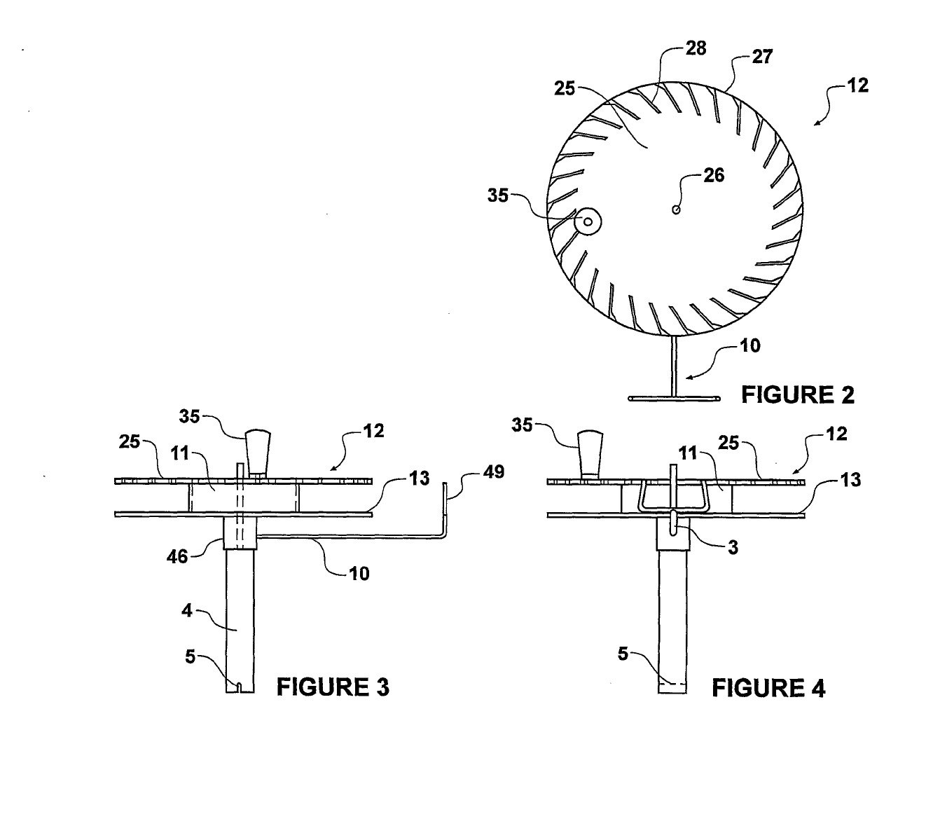

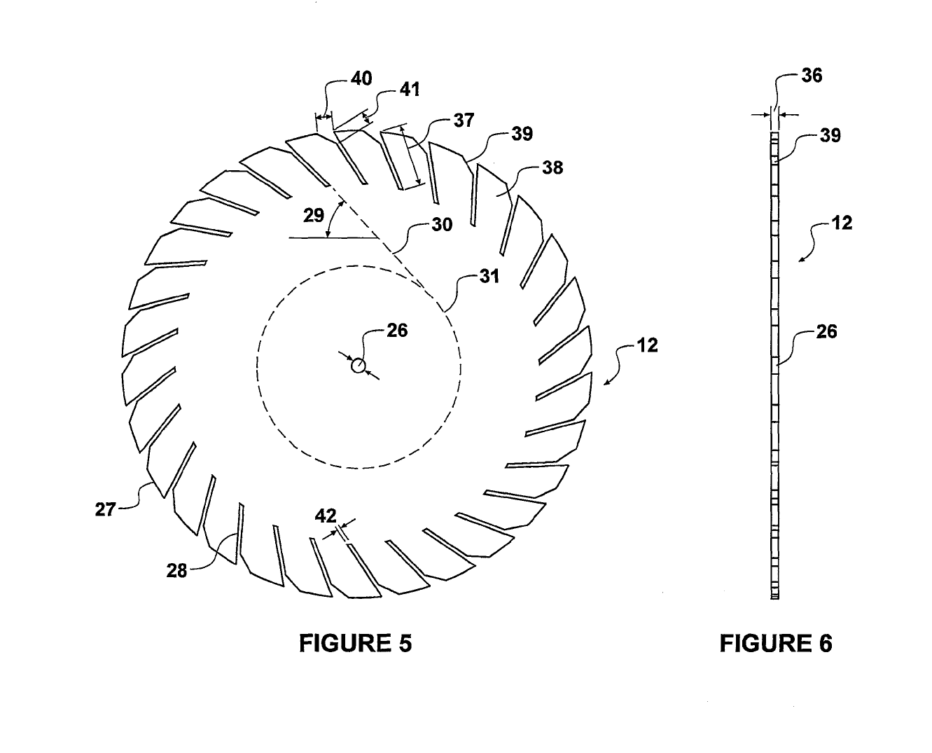

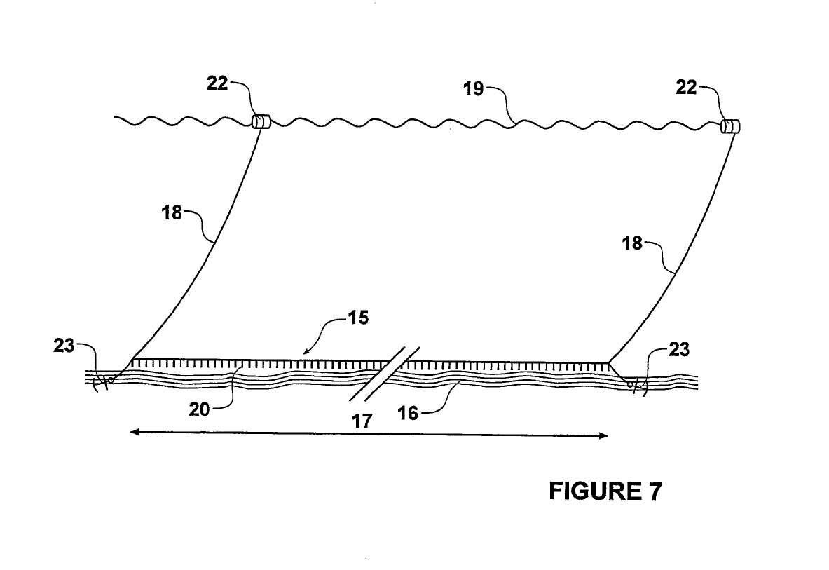

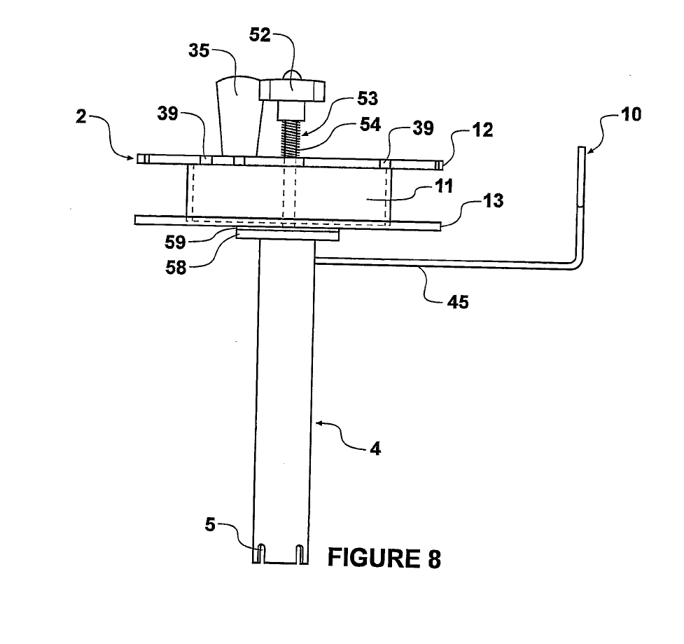

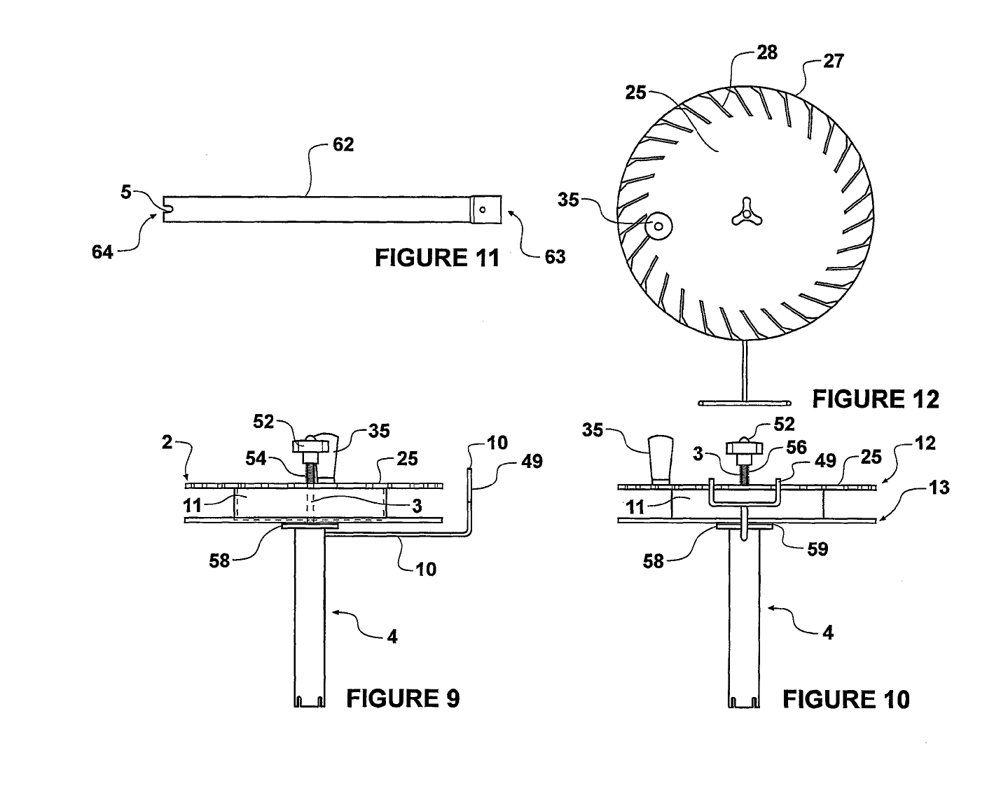

Optionally with or without the spindle extension portion 53, on top of the seat member 58 there can be a cushioning means 59 and/or friction relieving means in the form of at least one rubber member or specially made plastics member. In this example drag handle 52 as seen in FIGS. 8-12 can be in the shape of a triangular or three way solid shaped handle. Other handle shapes are equally possible.

Also shown in FIG. 11 there is shown a shaft extension member 62 being elongate and having a length with one end 63 being shaped to removably join the lower end of shaft member 4 and also having another end 64 distal to end 63, being adapted to be located in a hole 6 of the support surface. One end 63 can be shaped having a sleeve like member which is sized to provide an internal recess to allow one end (eg the end with the slots or notches 5) of shaft 4 there in. End 64 can also have the same slots or notches 5 as the shaft 4 has. Other means of jointing the extension member are also possible such as by bracket or telescoping or folding mechanisms.

### Deployment

The guide means 10 is secured in the inboard position with respect to the boat, so that the reel 2 cannot get in the way of the line being deployed. A float or danbouy 22 is clipped to the dropper 18 on the reel 2 and the dropper line 18 is then run out (ie because the reel is moving away from an end of the fishing line eg boat moves with respect to the float, the reel is caused to rotate in one direction or forward direction) as the boat motors away upwind or drifts downwind. When the other end of the dropper line l8 appears on the reel 2, an anchor weight 23 is then clipped on to a junction of the dropper line/backbone line 15 and dropper line 18.

As the anchor weight 23 is dropped to the seafloor, lakebed or riverbed, the movement of the anchor weight with respect to the boat causes the reel to further rotate with respect to the shaft member 4, the backbone line 15 to run out which pulls the trace lines 20 with baited hooks from the hook carousel in sequence to set the long line on the seafloor. When a backbone line 15 and second dropper line 18 junction appears, a second anchor weight 23 is then clipped on. The second dropper line 18 is run out and a float/danbouy 22 then attached to free end of the dropper line 18.

### Retrieval

The line guide 10 of the long line fishing apparatus 1 is set to an outboard position to support the incoming line. The first float/danbouy 22 is then unclipped from its dropper line 18, the dropper line 18 is clipped to the reel 2 and the dropper line 18 is then reeled in manually over the guide means 10. The first anchor weight 23 is unclipped and the backbone line 18 is then reeled in.

As each trace line 20 is recovered, any fish or remaining bait is removed from the hook and the hook is secured to the slots 28 of the upper wall 12 of the reel with a slight tension on the trace line 20. With all hooks re-secured on the upper reel flange wall 12 of the reel 2, the second anchor weight 23 is unclipped, the second dropper line 18 is then reeled in and the second float/danbouy 22 unclipped.

### Construction

The long line fishing apparatus 1 is built to last. The apparatus can be made from UV stabilised PVC and marine grade 316 stainless steel mounted onto a mounting shaft 4, the only components that may need replacing over the next year or two are the trace lines 20 and hooks. For example the mounting shaft 4 can be made from wood or steel or stainless steel.

The dropper lines 18, backbone line 15, trace lines 20 and hooks are spooled CCW onto the reel 2 with each of the hooks held securely by line tension in one of the slots 28 of the upper reel flange wall 12 of the reel 2. The tension on the trace lines 20 ensures that the hooks are held point down, minimising the risk of hook injuries to the operator's hands.

In this example the reel 2 is mounted on spindle 3 supported by a wooden shaft 4 which fits into a standard vertical rod-holder 6 in a boat. A stainless steel sleeve member portion 46 is fitted over the top of the shaft 4, to which is welded a stainless steel line guide 10. There is a cutout or slot in the bottom of the shaft 4 allows the line guide 10 to be locked inboard during deployment of the long line or outboard during retrieval.

Following is another summary of the steps involved in deploying or retrieving a long line using the long line fishing apparatus 1 using for example a backbone line with two anchors 23 ie one at each end of the backbone line 15. Also having a first dropper line 18 at one end and a second dropper line at the other end of the backbone line 15, each with a float 22.

### Deploying or Shooting the Long Line Fishing Apparatus

1. Insert the long line shaft 4 into a vertical rod-holder 6.
2. Mount the long line reel 2 on the spindle 3 at the top of the shaft 4 with the guide means 10 locked in an inboard position.
3. Fix baits to the hooks on the top of the reel ie on surface 25 (The hooks can be baited earlier), preferably ensuring that the baited hooks are laid outwards as the centrifugal force of the rotating reel 2 during shooting/deploying will tend to throw the baits outwards. This is particularly important for a pair of hooks in the same slot 28, to ensure that the hooks are not crossed.
4. Attach a float 22 to the free end of the dropper line 18 on the reel 2.
5. Drift or motor away from the float 22, allowing the reel to rotate causing the dropper line 18 to spool out.
6. When a dropper line/backbone line 18 knot appears, attach an anchor weight 23 to the adjacent loop in the dropper line 18.
7. As the anchor weight drops or moves away from the boat or as the anchor moves away from the reel, the reel further rotates causing the backbone line 15 to continue to run out. The baited hooks will be automatically pulled out of their slots as the reel rotates so that the backbone line 15 pulls the trace lines 20 from the reel 2.
8. When the backbone/dropper knot appears, attach an anchor weight to the adjacent loop in the dropper line 18.
9. Again the movement of the anchor weight away from the boat or reel, causes the reel to rotate with the dropper line 18 continuing to run out.
10. When the end of the dropper line 18 appears at the reel, unclip the dropper line 18 from the reel 2, clip on the second float 22 and drop it outboard.

The long line fishing apparatus 1 is now set to allow the user to do other things like rod-fishing, skiing or sailing.

### Hauling in or Retrieving the Long Line

1. With the guide means 10 locked in the outboard position, bring the windward float 22 aboard.
2. Unclip the float 22 from the dropper line 18, feed the line over the guide means 10 and clip it to the loop on the reel 2. The guide means 10 ensures that the line is fed directly to the reel 2, no matter what direction it comes to the boat.
3. Lighten the tension on the dropper line 18 by taking the weight of the long line by hand and spool the dropper line 18 onto the reel 2 for a couple of turns, until there is enough friction between dropper line 18 and reel hub 11 for the weight to be taken by the reel 2.
4. Reel in the dropper line 18 by manually turning/rotating the reel 2 in a counter clockwise direction (CCW) direction.
5. When the dropper line/backbone line knot appears, unclip the anchor from the adjacent loop.
6. Reel in the backbone by manually turning the reel in a CCW direction.
7. As each trace line 20 and hook appears, remove the fish or bait and secure the hook in one of the slots by pulling the trace line 20 around the reel in a CCW direction (the same way the backbone line is spooling on to the hub 11), keeping a little tension on the trace line 20. This tension ensures that the hook is held point-down. In this example there are thirty slots 28 for twenty five hooks and the operator should try to ensure that there is no more than one hook in any slot 28, though it is acceptable to double up if necessary.
8. As the far end of the backbone line 15 comes aboard, unclip the second anchor 23 from the adjacent loop.
9. Spool the dropper line 18 onto the hub 11 of the reel 2.
10. Unclip the float 22 from the dropper line if the long line fishing apparatus 1 is to be stowed away. Alternatively, the long line fishing apparatus 1 may be re-baited and reset.

To those skilled in the art to which the invention relates, many changes in construction and widely differing embodiments and application of the invention will suggest themselves without departing from the scope of the invention as defined in the appended claims. The disclosures and the descriptions herein are purely illustrative and are not intended to be limiting.

It will also be understood that where a product, method or process as herein described or claimed and that is sold incomplete, as individual components, or as a “kit of Parts”, that such exploitation will fall within the ambit of the invention.

These and other features and characteristics of the present invention, as well as the method of operation and functions of the related elements of structures and the combination of parts and economics of manufacture, will become more apparent upon consideration of the following description with reference to the accompanying drawings, all of which form part of this specification, wherein like reference numerals designate corresponding parts in the various figures.

The drag handle can be any shape. The biasing means 54 can be provided by other shaped springs or means that still allows the handle to be rotated to slow down the movement/rotation of the reel 2 and there can be more than one spring or biasing means. These fittings can be removably fitted or be fixed. The shaft 4 and or shaft extension member 52 can be of similar or different diameters. There can be any number of seating members that fitting in between the lower wall 13 of the reel 2 to enhance the rotation and or control of the rotation of the reel.

For purposes of the description hereinafter, the terms “upper”, “lower”, “right”, “left”, “vertical”, “horizontal”, “top”, “bottom”, “lateral”, “longitudinal” and derivatives thereof shall relate to the invention as it is oriented in the drawing figures. However it is to be understood that the invention may assume various alternative variations, except where expressly specified to the contrary. It is also to be understood that the specific devices illustrated in the attached drawings, and described in the following specification are simply exemplary embodiments of the invention. Hence specific dimensions and other physical characteristics related to the embodiments disclosed herein are not to be considered as limiting.

### Advantages

a) Combines a fishing table/tracer board with a feed out apparatus
b) Simple operation
c) Easy to assemble
d) Simple manufacture
e) Modest cost
f) Allows ready attachment of bait directly to the apparatus
g) No need for separate tracer board
h) Reduces chances of line tangling
i) Quick operation to lay out long line and to retrieve
j) Setup can be done before sailing e.g. put in freezer the night before
k) Boat movement does not affect the operation of the apparatus
l) Fits into standard rod handle holder hole
m) The reel rotation can be adjusted by using a clutch mechanism
n) Can be hand held or used in a portable holding device

### VARIATIONS

Throughout the description of this specification, the word “comprise” and variations of that word such as “comprising” and “comprises”, are not intended to exclude other additives, components, integers or steps.

The connection between the reel 2 and shaft can be varied as long as the reel is able to rotate horizontally while allowing the guide means 10 to function properly to guide the line to reduce the likelihood of line entangling. The number, angles and size of slots 28 can be varied depending on the size of fishing line and what is being attempted to be caught plus allow for different country fishing rules. In one example the connection can be fixed together but still allow rotation or it can be easily removable or demountable. The shaft member 4 can be of any suitable diameter, cross section and shape such as for example square cross section or be slotted or articulated.

Though the guide means 10 shows only one horizontal elongate portion U shaped portion 48 there can be more than one and it can be formed of other shapes such as square shaped with different widths between the arms. Also the shape of the U shaped portion can also be varied as long as there is some means to guide a fishing line there through. For example, the guide means 10 can be a square U or a solid member with a slot therein or some other shape having a U as a portion thereof. The guide means 10 can be formed as a separate member to the shaft member 4 or it can be integrally formed with the shaft member 4. The guide means 10 though shown having a horizontal portion 45 joined at right angles to the vertical member 45a and then to the U shape, can have any other support shapes or angles for items 45, 45a and U, as long as a guide is provided is the position close to the reel and fishing line. For example members 45, 45a and the U can be formed from plate or rod or tube in any combination. The guide means 10 can be located closer to an upper end of the shaft member but other positions on the shaft member 4 are also possible as long as the fishing line is guided from the reel to the water and back again.

In New Zealand and other countries, the number of slots with hooks is restricted though other rules apply to different situations like for example 9 to 15 slots for 6-12 hooks with a reel wall diameter of 9 or 10 inches intended for use from kayaks or dinghies. There can be a standard reel of 14 inches diameter with 30 slots for a nominal 25 hooks and a reel having a 24 inch diameter with 60 slots and nominally 100 hooks.

A boat rod holder is usually the most convenient method of affixing the longline fishing apparatus but other methods and position are equally possible as long as the reel is able to rotate in the horizontal plane while the shaft member 4 is being held in position. For example the rod hold may be positioned elsewhere in the boat such as in a angled or a vertical position meaning that the shaft 4 will have to angled accordingly. For kayaks and dinghies, the shaft 4 of these can be modified to suit available fittings such as rowlock sockets provided on dinghies. In yet another variation the shaft member can be held in any other means such as by hand or in a portable launcher or hand held device.

It will of course be realised that while the foregoing has been given by way of illustrative example of this invention, all such and other modifications and variations thereto as would be apparent to persons skilled in the art are deemed to fall within the broad scope and ambit of this invention as is hereinbefore described.

It will also be understood that where a product, method or process as herein described or claimed and that is sold incomplete, as individual components, or as a “kit of Parts”, that such exploitation will fall within the ambit of the invention.

These and other features and characteristics of the present invention, as well as the method of operation and functions of the related elements of structures and the combination of parts and economics of manufacture, will become more apparent upon consideration of the following description with reference to the accompanying drawings, all of which form part of this specification, wherein like reference numerals designate corresponding parts in the various figures.

For purposes of the description hereinafter, the terms “upper”, “lower”, “right”, “left”, “vertical”, “horizontal”, “top”, “bottom”, “lateral”, “longitudinal” and derivatives thereof shall relate to the invention as it is oriented in the drawing figures. However it is to be understood that the invention may assume various alternative variations, except where expressly specified to the contrary. It is also to be understood that the specific devices illustrated in the attached drawings, and described in the following specification are simply exemplary embodiments of the invention. Hence specific dimensions and other physical characteristics related to the embodiments disclosed herein are not to be considered as limiting.

1-17. (canceled)

18. A long line fishing apparatus comprising a reel able to rotate in one direction for unwinding and in an opposing direction for winding the fishing line on to the reel and hook retaining means, the reel including a core connected between a first flange and second flange, for winding or unwinding a fishing line thereon said core between the first and second flanges, at least one of the flanges having an outer periphery edge and a centre of rotation, the fishing line including at least one hook, the reel being pivotally attached to the support member, and hook retaining means being formed as at least one slot in the first flange so that the at least one hook can be retained in the at least one slot wherein each slot is orientated at an angle with respect to the periphery edge wherein the angle includes an acute angle and obtuse angle, whereby the acute angle is provided on a leading side of each slot when unwinding and is provided on a trailing side of each slot when winding, wherein the slots are sized to only receive the line whereby the hooks protrude on top of the first flange.

19. The long line fishing apparatus as claimed in claim 18 wherein the fishing line has a dropper backbone whereby the hooks are removably attached to trace lines and the said an end of the fishing line has at least one float and/or at least one anchor weight there attached whereby movement of the reel with respect to the end of the fishing line is caused by movement of at least one float or anchor weight moving away from the reel.

20. The longline fishing apparatus as claimed in claim 19 wherein the apparatus includes a guide means attached to a support member.

21. The long line fishing apparatus as claimed in any one of claims 20 wherein, the support member is a shaft having ends, being vertically mountable in a hole on a support surface of a boat wherein one end of the shaft is slotted to allow the shaft to not move when the reel is being moved and the other end being removably attached to the reel.

22. The long line fishing apparatus as claimed in any one of claims 21 wherein the first and second flanges can be circular in shape and the first flange in use is an upper flange which is parallel to the second flange which in use is a lower flange.

23. The long line fishing apparatus as claimed in claim 22 wherein the reel is oriented at right angles to the shaft.

24. The long line fishing apparatus as claimed in claim 23 wherein the other end is an upper end of the shaft which includes a protruding portion that is slidably mounted within a complementary aperture in the centre of the reel enabling the reel to rotate around and about the protruding portion.

25. The long line fishing apparatus as claimed in claim 22 wherein, the upper flange is adapted to provide an outer surface for use as a baiting table and storage for baited or un-baited hooks on trace lines.

26. The long line fishing apparatus as claimed in claim 25, wherein each slot extends at least a portion of the distance from the periphery edge to a centre of rotation of the reel.

27. The long line fishing apparatus as claimed in claim 23 wherein, the slots are angled tangentially to a diameter of a circle of the reel, being greater than 100 mm whereby the slots are not parallel with one another, and only allow the line there through.

28. The long line fishing apparatus as claimed in claim 27 wherein, each slot has at least one bevelled corner at an entrance to the slot to assist in allowing the fishing line to be wound or unwound on to a hub of the reel and into or out of each slot, wherein the bevelled corner is located on a rear or trailing side of the entrance of each slot when unwinding.

29. The long line fishing apparatus as claimed in claim 28 wherein, the guide means comprises a slotted member attached to a horizontal elongate member wherein the slotted member is oriented vertically to provide an upwardly facing guide slot, which is spaced from a periphery of the reel and is located substantially adjacent the fishing line as stored on the core between the first and second flanges to allow suitable guiding wherein the slotted member is a U-shaped member.

30. The long line fishing apparatus as claimed in claim 29 wherein there is provided a clutch mechanism shaped and adapted to slow down or not the reel with respect to the shaft, wherein the clutch mechanism includes a spindle extension member which extends from the spindle above the upper flange of the reel, having biasing means surrounding the spindle extension which is held on the spindle extension member and the upper flange by a threadably engaged operating handle so that the reel is seated on a seat member on the top of the shaft, whereby the reel is sandwiched between the biasing means with the handle and the seat member such that rotation of the reel is restricted slowed or released.

31. The long line fishing apparatus as claimed in claim 30 wherein there is provided at least one shaft extension member adapted to removably join a lower end of the shaft and whereby the shaft extension member has a lower end adapted to be located in the hole of the support surface of a boat and an upper end adapted to slidably receive the lower end of the shaft.

32. A method of retrieving a longline to a longline fishing apparatus of claim 1 wherein the method includes:
1. Winding a reel in a certain direction whereby the line is wound around the reel.
2. Further winding causes each hook on a tracer to be would in the same direction to be clipped onto adjacent slot to be in tension without tangling.

33. A long line fishing apparatus as claimed in claim 18 substantially as herein described with reference to the figures of the accompanying drawings.

34. A method of deploying a long line from a long line fishing apparatus long line fishing apparatus as claimed in claim 32 substantially as herein described with reference to the figures of the accompanying drawings.

35. A method of retrieving a long line from a long line fishing apparatus long line fishing apparatus as claimed in claim 33 substantially as herein described with reference to the figures of the accompanying drawings.
